(19) United States
(12) Patent Application Publication
(10) Pub. No.: US 2024/0145923 A1
(43) Pub. Date: May 2, 2024

(54) INFORMATION PROCESSING APPARATUS AND TOUCH PANEL

(71) Applicant: NEC Corporation, Minato-ku, Tokyo (JP)

(72) Inventors: Koya Takata, Tokyo (JP); Kenji Wakafuji, Tokyo (JP); Fujio Okumura, Kanagawa (JP)

(73) Assignee: NEC Corporation, Minato-ku, Tokyo (JP)

(21) Appl. No.: 18/279,009

(22) PCT Filed: Dec. 10, 2021
(86) PCT No.: PCT/JP2021/045694

§ 371 Date: Aug. 25, 2023

(30) Foreign Application Priority Data
Mar. 30, 2021 (JP) 2021-056695

(51) Int. Cl. H01Q 9/04; G06F 3/042; G06F 3/046; H01Q 1/24

(52) U.S. Cl. CPC H01Q 9/0421; G06F 3/042; G06F 3/046; H01Q 1/243; G06F 3/044

(57) ABSTRACT

A display board (101) configured to include a first display element (102A) that displays a first pixel that is one pixel of a screen of the touch panel and a second display element (102B) that displays a second pixel that is other one pixel of the screen; a touch sensor (106, 201, 203) configured to detect contact with the screen; a planar antenna (105) configured to be provided at a position on a front surface side of the screen with respect to the display board and the touch sensor, the position not facing the first display element and the second display element when viewed from above the screen; and a control unit configured to communicate to the planar antenna via a space between the first display element and the second display element.

### TECHNICAL FIELD

The present disclosure relates to an information processing apparatus and a touch panel.

### BACKGROUND ART

In recent years, it has been studied to increase the speed and capacity of wireless communication using radio waves in a high frequency band such as millimeter waves (for example, a radio wave having a frequency of about 30 GHz to 300 GHz) and terahertz waves (for example, a radio wave having a frequency of about 300 GHz to 3000 GHz (3 THz)).

The higher the frequency used for wireless communication, the shorter the communicable distance by one antenna. Therefore, there is known a technique of increasing a communicable distance by increasing the number of antennas (see, for example, Patent Literature 1).

### CITATION LIST

### Patent Literature

Patent Literature 1: Japanese Unexamined Patent Application Publication No. 2020-053942

### SUMMARY OF INVENTION

### Technical Problem

However, with the technique described in Patent Literature 1, for example, it may be difficult to increase the communicable distance. This is because the housing of the wireless communication apparatus needs to be enlarged in order to increase the number of antennas.

In view of the above-described problem, an object of the present disclosure is to provide an information processing apparatus and a touch panel capable of increasing a communicable distance in wireless communication.

### Solution to Problem

According to a first aspect of the present disclosure, an information processing apparatus including a touch panel includes: a display board configured to include a first display element that displays a first pixel that is one pixel of a screen of the touch panel and a second display element that displays a second pixel that is one pixel different from the first pixel of the screen; a touch sensor configured to detect contact with the screen; a planar antenna configured to be provided at a position on a front surface side of the screen with respect to the display board and the touch sensor, the position not facing the first display element and the second display element when viewed from above the screen; and a control unit configured to perform at least one of reception of a signal from the planar antenna and transmission of a signal to the planar antenna via a space between the first display element and the second display element.

In addition, according to a second aspect of the present disclosure, there is provided a touch panel including: a display board configured to include a first display element that displays a first pixel that is one pixel of a screen of the touch panel and a second display element that displays a second pixel that is one pixel different from the first pixel of the screen; a touch sensor configured to detect contact with the screen; a planar antenna configured to be provided at a position on a front surface side of the screen with respect to the display board and the touch sensor, the position not facing the first display element and the second display element when viewed from above the screen; and a control unit configured to perform at least one of reception of a signal from the planar antenna and transmission of a signal to the planar antenna via a space between the first display element and the second display element.

### Advantageous Effects of Invention

According to one aspect, a communicable distance in wireless communication can be increased.

### BRIEF DESCRIPTION OF DRAWINGS

FIG. 1 is a diagram illustrating a configuration example of a wireless communication system according to an example embodiment.

FIG. 2 is a diagram illustrating an example of a configuration of a touch panel according to a first example embodiment.

FIG. 3 is a diagram illustrating an example of arrangement of display elements and planar antennas according to the first example embodiment.

FIG. 4 is a diagram illustrating an example of arrangement of display elements and planar antennas according to the first example embodiment.

FIG. 5 is a diagram illustrating an example of a touch sensor according to the first example embodiment.

FIG. 6 is a diagram illustrating an example of the touch sensor according to the first example embodiment.

FIG. 7 is a flowchart illustrating an example of processing of a control unit according to the example embodiment.

FIG. 8 is a diagram illustrating an example of an arrangement density of the planar antenna according to the example embodiment.

FIG. 9 is a diagram illustrating an example of a configuration of a touch panel according to a second example embodiment.

FIG. 10 is a diagram illustrating an example of arrangement of display elements, an optical sensor, and planar antennas according to the second example embodiment.

FIG. 11 is a diagram illustrating an example of arrangement of display elements, an optical sensor, and planar antennas according to the second example embodiment.

FIG. 12 is a diagram illustrating an example of a control unit according to the example embodiment.

FIG. 13 is a diagram illustrating an example of a configuration of a touch panel according to a third example embodiment.

### EXAMPLE EMBODIMENT

The principles of the present disclosure will be described with reference to several exemplary example embodiments. It is to be understood that these example embodiments have been described for purposes of illustration only and will aid those skilled in the art in understanding and carrying out the present disclosure without suggesting limitations on the scope of the present disclosure. The disclosure described in the present description is implemented in various methods other than those described below.

In the following description and claims, unless defined otherwise, all technical and scientific terms used in the present disclosure have the same meaning as commonly understood by those skilled in the art of the technical field to which the present disclosure belongs.

Hereinafter, example embodiments of the present invention will be described with reference to the drawings.

<System Configuration>

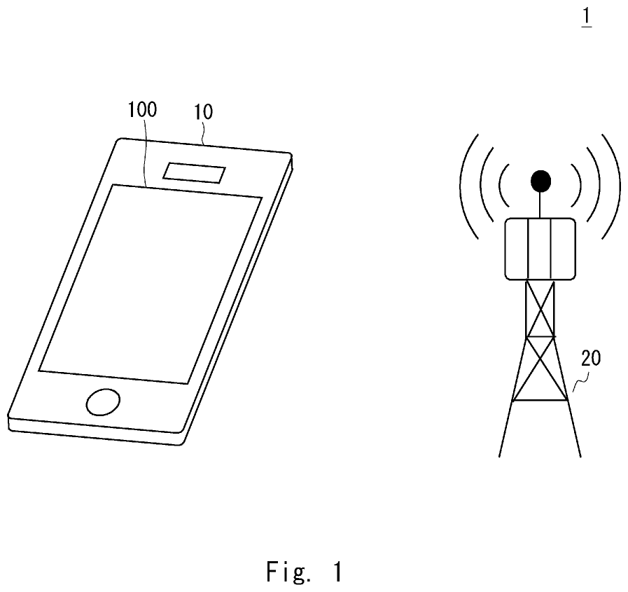

FIG. 1 is a diagram illustrating a configuration example of a wireless communication system 1 according to an example embodiment. In FIG. 1, the wireless communication system 1 includes an information processing apparatus 10 and a base station 20. Note that the numbers of the information processing apparatuses 10 and the base stations 20 are not limited to the example of FIG. 1.

The information processing apparatus 10 and the base station 20 are connected so as to be capable of communication by, for example, wireless communication. Note that a range (coverage) in which the information processing apparatus 10 can receive a radio wave from the base station 20 is also referred to as a cell.

The “wireless communication” described in the present disclosure may conform to standards such as a 6th generation mobile communications system (6G, Beyond 5G), a 5th generation mobile communications system (5G), a 4th generation mobile communication system (4G), or wireless local area network (LAN). Note that 4G may include, for example, long term evolution (LTE) advanced, WiMAX2, and LTE. In addition, the wireless communication of the present disclosure may also be executed in accordance with any generation of wireless communication protocols now known or developed in the future. Note that “downlink” used in the present disclosure refers to a link from the base station 20 to the information processing apparatus 10, and “uplink” refers to a link from the information processing apparatus 10 to the base station 20.

The term “base station” (BS) used in the present disclosure refers to a device that can provide or host a cell or coverage in which the information processing apparatus 10 can communicate. Examples of the base station 20 include, for example, a base station or a repeater in non-terrestrial networks (NTN). In this case, the base station 20 may be mounted on, for example, a geostationary satellite, a non-geostationary satellite, a high altitude platform station (HAPS), an aircraft, an airship, a drone, a balloon, or the like.

In addition, examples of the base station 20 include, for example, an NR NodeB (gNB), a NodeB (or NB), an Evolved NodeB (eNodeB or eNB), a remote radio unit (RRU), and the like. In addition, examples of the base station 20 include, for example, but are not limited to, a radio head (RH), a remote radio head (RRH), a low power node (for example, femto node, pico node), and the like.

The information processing apparatus 10 includes a touch panel 100. The touch panel 100 is an electronic component in which a display apparatus and a position input apparatus are combined. The user of the information processing apparatus 10 can perform an intuitive operation by tapping, flicking, swiping, pinching, multi-touching, or the like on the display screen displayed on the touch panel 100.

The term “information processing apparatus” used in the present disclosure refers to any device having a wireless communication function and the touch panel 100. Examples of the information processing apparatus 10 include a smartphone, a tablet, a digital signage (electronic signage), a wearable device such as a smart watch, a personal computer, a mobile phone, user equipment (UE), and the like. In addition, examples of the information processing apparatus 10 include a portable game machine, a digital camera, a music player, a personal digital assistant (PDA), a portable computer, and the like.

### First Example Embodiment

<Configuration>

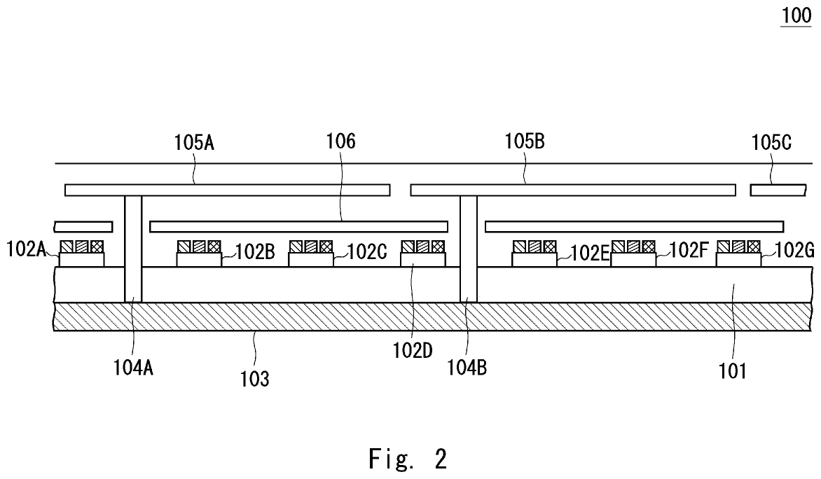

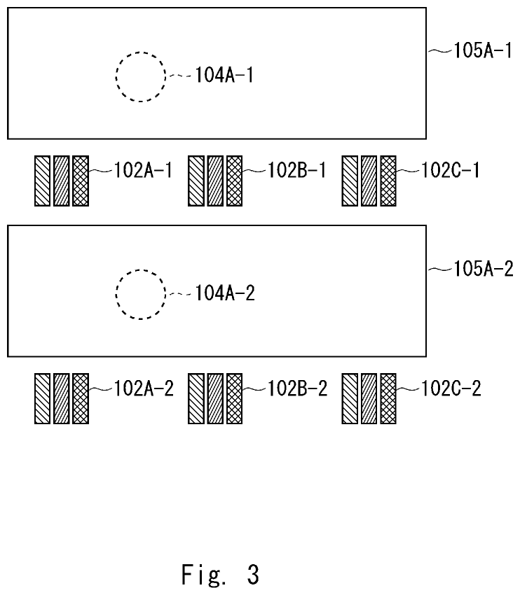

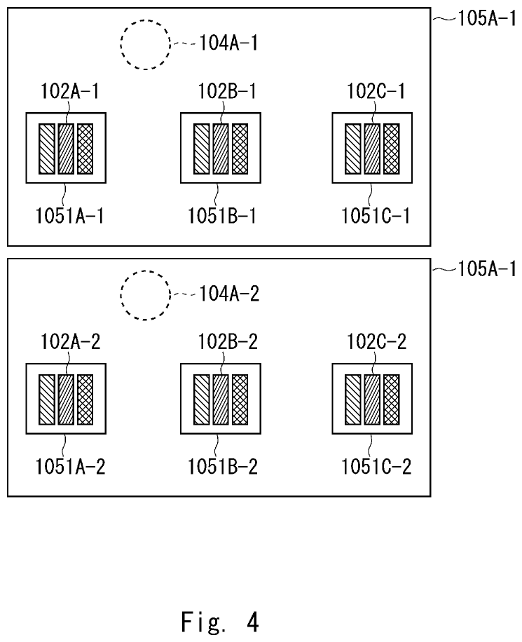

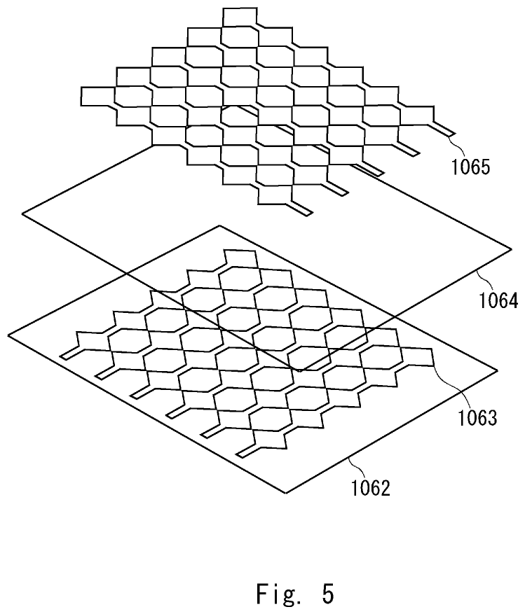

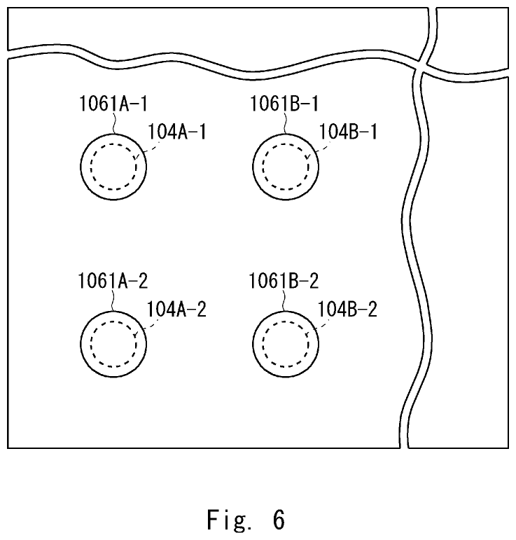

Next, an example of a configuration of the touch panel 100 of the information processing apparatus 10 according to the first example embodiment will be described with reference to FIGS. 2 to 6. FIG. 2 is a diagram illustrating an example of a configuration of the touch panel 100 according to the first example embodiment. FIGS. 3 and 4 are diagrams illustrating an example of arrangement of display elements 102 and planar antennas 105 according to the first example embodiment. FIGS. 5 and 6 are diagrams illustrating an example of a touch sensor 106 according to the first example embodiment.

FIG. 2 illustrates an example of a cross-sectional diagram of a part of the touch panel 100 according to the example embodiment. In the example of FIG. 2, the touch panel 100 includes a display board 101, the touch sensors 106, a planar antenna 105A, a planar antenna 105B, and a planar antenna 105C (hereinafter, in a case where there is no need to distinguish, the planar antennas are simply referred to as “planar antenna 105”). In addition, the touch panel 100 includes a support 104A, a support 104B, and a support 104C (hereinafter, in a case where there is no need to distinguish, the supports are simply referred to as “support 104”), and a control unit 103.

The control unit 103 and the display board 101 may be directly connected by a terminal (port) of the control unit 103 and a terminal of the display board 101. In addition, the control unit 103 and the display board 101 may be connected by a cable. In addition, the control unit 103 and the touch sensor 106 may be connected by, for example, a cable passing through a portion outside the screen of the touch panel 100.

The display board 101 is a display apparatus that displays the display screen of the touch panel 100. The display board 101 includes a display element 102A, a display element 102B, a display element 102C, a display element 102D, a display element 102E, and a display element 102F (hereinafter, in a case where there is no need to distinguish, the display elements are simply referred to as “display element 102”). One display element 102 displays one pixel of the display screen of the touch panel 100. In a case where the display screen of the touch panel 100 is a color display, one display element 102 may have at least three light emitting diodes (LEDs), for example, an LED that emits red light, an LED that emits green light, and an LED that emits blue light. Note that the display element 102 in this case is also referred to as a micro LED or the like.

The display board 101 is provided with the same number of display elements 102 as the number of pixels of the display screen of the touch panel 100. Therefore, for example, when the screen resolution of the touch panel 100 is full high definition (FHD), the display board 101 is provided with 2073600(=1920×1080) display elements 102.

The touch sensor 106 detects contact of an object such as a finger and a touch pen (stylus pen) with the screen of the touch panel 100. The touch sensor 106 may acquire a position on the screen of the touch panel 100 at which a finger or the like is in contact, a time at which contact with the position is started, a time at which contact with the position is ended, and the like.

As illustrated in FIG. 2, the planar antenna 105 is provided on the front surface side (a position closer to the front surface) of the screen of the touch panel 100 with respect to the display board 101 and the touch sensor 106. The planar antenna 105 may be, for example, a patch antenna. The planar antenna 105 may be a small-sized patch antenna. In this case, the planar antenna 105 may be, for example, a one-side short-circuited patch antenna having a short-circuit portion (for example, a short circuit plate) at one end in a lateral direction (lateral direction in FIG. 2), a length (height) in the lateral direction being ¼ wavelength, and a length (width) in the vertical direction (depth direction in FIG. 2) being ½ wavelength. The planar antenna 105 may be, for example, a planar inverted-F antenna (PIFA) having a short-circuit portion (for example, a short-circuit pin) at one end in a lateral direction, a length (height) in the lateral direction being ¼ wavelength, and a width in the vertical direction less affecting the resonance frequency being smaller than ¼ wavelength. Each planar antenna 105 may be formed on the same board by a microstrip, a stripline, or the like.

An insulating layer is provided between the touch sensor 106 and the planar antenna 105. Thus, electromagnetic interference between the planar antenna 105 and the touch sensor 106 can be reduced. The insulating layer may be an air layer (space). In addition, the insulating layer may be a layer of plastic, glass, or the like. Thus, the strength when the screen of the touch panel 100 is pressed can be increased.

The control unit 103 performs at least one of reception of a signal from the planar antenna 105 and transmission of a signal to the planar antenna 105 in a wired or wireless manner via spaces between the plurality of display elements 102 on the display board 101. In the example of FIG. 2, the planar antenna 105 is supported by (fixed to) the display board 101 by the support 104 passing between the plurality of display elements 102 on the display board 101. At least one planar antenna 105 of the plurality of planar antennas 105 and the control unit 103 may be connected by wire by a direct power supply (for example, coaxial feed) method using, for example, the support 104 having a conductor (for example, copper) as a conductive wire.

At least one planar antenna 105 of the plurality of planar antennas 105 and the control unit 103 may be wirelessly connected by, for example, an electromagnetic coupling feed (for example, slot-coupled feed, or proximity-coupled feed) method. Note that when the control unit 103 and the planar antenna 105 are connected by electromagnetic coupling feed, the support 104 may be formed of resin (for example, plastic) having no conductor. In addition, in a case where the control unit 103 and the planar antenna 105 are connected by electromagnetic coupling feed, the touch panel 100 may not include the support 104. In this case, each planar antenna 105 may be formed on the same board, and the board may be supported by an end of the touch panel 100.

FIGS. 3 and 4 illustrate examples of arrangement of the display elements 102, the planar antennas 105, and the like in a case where a part of the screen of the touch panel 100 according to the first example embodiment is viewed from above. Note that all the display elements 102 and all the planar antennas 105 of the touch panel 100 may be arranged in either one of as in FIGS. 3 and 4. In addition, some of sets of one or more display elements 102 and one or more planar antennas 105 of the touch panel 100 may be arranged as in FIG. 3, and the remaining sets may be arranged as in FIG. 4.

In FIGS. 3 and 4, the depth direction in FIG. 2 is illustrated as a vertical direction. Therefore, a set of a display element 102A-1, a display element 102B-1, a display element 102C-1, a planar antenna 105-1, and a support 104A-1 in FIGS. 3 and 4 corresponds to a set of the display element 102A, the display element 102B, the display element 102C, the planar antenna 105, and the support 104A in FIG. 2. Similarly, a set of a display element 102A-2, a display element 102B-2, a display element 102C-2, a planar antenna 105-2, and a support 104A-2 in FIGS. 3 and 4 also corresponds to a set of the display element 102A, the display element 102B, the display element 102C, the planar antenna 105, and the support 104A in FIG. 2.

In the example of FIG. 3 and the example of FIG. 4, the planar antenna 105 is provided at a position not facing each display element 102 as viewed from above the screen of the touch panel 100 (the user side of the information processing apparatus 10). Thus, since the light by each display element 102 is not blocked by the planar antenna 105, the display screen by the light emission of each display element 102 can be shown to the user.

In the example of FIG. 3, each planar antenna 105 is provided at a position between a display element 102 (for example, display element 102-1) and another display element 102 (for example, display element 102-2) as viewed from above the screen of the touch panel 100. In addition, in the example of FIG. 4, each planar antenna 105 has openings 1051A-1, 1051A-2, 1051B-1, 1051B-2, 1051C-1, and 1051C-2 (hereinafter, in a case where there is no need to distinguish, the openings are simply referred to as “opening 1051”) at positions facing the display elements 102A-1, 102A-2, 102B-1, 102B-2, 102C-1, and 102C-2, respectively, when viewed from above the screen of the touch panel 100.

FIG. 5 illustrates an example of the touch sensor 106 according to the example embodiment. FIG. 5 illustrates a projected capacitive type touch sensor as an example of the touch sensor 106 according to the example embodiment. In the example of FIG. 5, the touch sensor 106 includes a glass substrate 1062, a horizontal transparent electrode layer 1063, an adhesive 1064, and a horizontal transparent electrode layer 1065, and senses contact by a change in capacitance between the electrodes when a finger or the like is brought close to the surface of the screen. In addition, as illustrated in FIG. 6, the touch sensor 106 has openings 1061A-1, 1061A-2, 1061A-3, and 1061A-4 (hereinafter, in a case where there is no need to distinguish, the openings are simply referred to as “opening 1061”) at positions corresponding to supports 104A-1, 104A-2, 104B-1, and 104B-2, respectively. Note that, in a case where the control unit 103 and the planar antenna 105 are connected by electromagnetic coupling feed and the touch panel 100 does not include the support 104, the touch sensor 106 may not have the opening 1061.

Note that the touch sensor 106 may be provided on the back side of the screen with respect to the planar antenna 105 as long as it can detect contact with the screen of the touch panel 100. Therefore, the touch sensor 106 is not limited to the projected capacitive type, but any touch sensor for a touch panel other than the pressure-sensitive type can be used. In this case, the touch sensor 106 may be, for example, a touch sensor of an electromagnetic induction type or the like that receives electromagnetic energy by electromagnetic induction and detects a position when a dedicated pen that generates a magnetic field comes into contact with the screen.

<Processing>

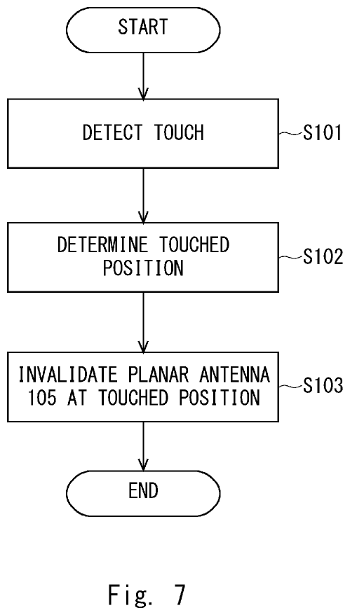

Next, an example of processing of the control unit 103 according to the example embodiment will be described with reference to FIG. 7. FIG. 7 is a flowchart illustrating an example of processing of the control unit 103 according to the example embodiment. In step S101, the control unit 103 detects contact (touch) on the screen of the touch panel 100 by using the touch sensor 106. Subsequently, the control unit 103 determines the touched position on the screen by using the touch sensor 106 (step S102).

Subsequently, the control unit 103 invalidates the planar antenna 105 corresponding to the touched position on the screen (step S103). Here, the control unit 103 performs at least one of reception and transmission by using the planar antenna 105 corresponding to a region other than the region on the screen where the touch is detected by the touch sensor 106. In this case, the control unit 103 may disuse each planar antenna 105 in a predetermined range (for example, within a radius of 2 cm) from the touched position while the screen is touched. Thus, in a case where the planar antenna 105 is used for downlink reception, it is considered that there is a possibility that noise of a reception signal can be reduced by disusing the planar antenna 105. In addition, in a case where the planar antenna 105 is used for uplink transmission, waste of power consumption can be reduced by disusing the planar antenna 105. This is because the millimeter wave and the terahertz wave have larger attenuation when passing through an object such as a finger on the screen as compared with a radio wave having a lower frequency.

<<Example of Invalidating Planar Antenna 105 at Position of Each Application>>

The control unit 103 may invalidate the planar antenna 105 corresponding to a position where the frequency of touching is high in advance for each application program. In this case, the control unit 103 may record the frequency of touching when display is performed on the screen of the touch panel 100 by a specific application program in each region on the screen. Then, the control unit 103 may disuse the planar antenna 105 in a region where the frequency (for example, the number of times per predetermined time) is equal to or greater than a threshold, and may perform at least one of reception and transmission using the planar antenna 105 corresponding to a region other than the region. Thus, noise reduction and energy saving can be further achieved as compared with the case of invalidating after touching as illustrated in FIG. 7.

<<Example of Invalidating Planar Antenna 105 at Position Such as Button>>

The control unit 103 may invalidate the planar antenna 105 corresponding to a position that is highly likely to be touched, such as a button, in advance. In this case, the control unit 103 may perform at least one of reception and transmission by using the planar antenna corresponding to a region other than a region on the screen where a graphical user interface (GUI) component for pressing is displayed. Thus, noise reduction and energy saving can be further achieved as compared with the case of invalidating after touching as illustrated in FIG. 7.

(Example of Changing Arrangement Density of Planar Antenna 105)

The density at which the planar antenna 105 is installed may be different according to each position on the screen of the touch panel 100. In this case, for example, a plurality of planar antennas 105 may be provided at a first density in a region of a central portion of the screen. Then, a plurality of planar antennas may be provided at a second density higher than the first density in a region of an edge portion of the screen. Thus, for example, as compared with a case where the planar antennas 105 are installed at a uniform density on the screen of the touch panel 100, the frequency at which the radio wave is shielded by the finger or the like is reduced, so that noise reduction and energy saving can be achieved. This is because it is considered that the closer to the end of the screen, the lower the frequency of touching by the user.

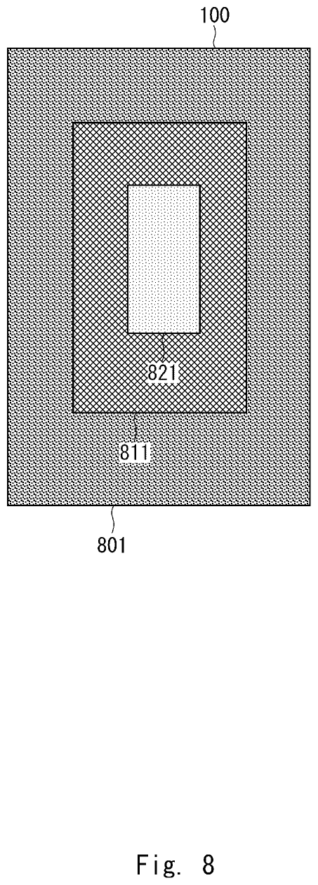

FIG. 8 is a diagram illustrating an example of an arrangement density of the planar antenna 105 according to the example embodiment. In the example of FIG. 8, the planar antennas 105 are provided at different densities for three regions 801, 811, and 821 according to the distance from the end of the screen. In the region 801 on the most end side, the planar antenna 105 is provided at the highest density. Then, in the region 811 closer to the center of the screen than the region 801 is, the planar antenna 105 is provided at a density lower than that of the region 801. Then, in the region 821 in the central portion of the screen, the planar antenna 105 is provided at a density lower than that of the region 811.

### Second Example Embodiment

In the above-described example, the example of using the touch sensor 106 of the projected capacitive type or the electromagnetic induction type has been described. Hereinafter, an example in which an optical sensor is used as the touch sensor will be described. Note that, in the following, a main part of the second example embodiment different from the first example embodiment will be described. Note that each unit of the first example embodiment and each unit of the second example embodiment can be appropriately combined and used. In this case, for example, the touch sensor 106 of the projected capacitive type or the electromagnetic induction type may be used for a partial region of the screen region of the touch panel 100. Then, a touch sensor using an optical sensor may be used for other regions of the screen region of the touch panel 100.

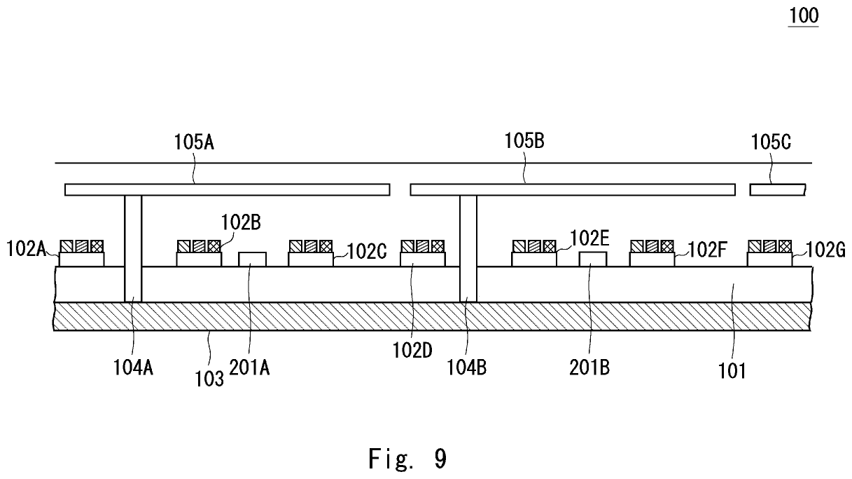

An example of a configuration of the touch panel 100 of the information processing apparatus 10 according to the second example embodiment will be described with reference to FIGS. 9 to 11. FIG. 9 is a diagram illustrating an example of a configuration of the touch panel 100 according to the second example embodiment.

In the example of FIG. 9, as compared with the example of FIG. 2, an optical sensor 201A and an optical sensor 201B (hereinafter, in a case where there is no need to distinguish, the optical sensors are simply referred to as “optical sensor 201”) are included instead of the touch sensor 106. Note that the optical sensor 201 is an example of the “touch sensor”. In the example of FIG. 9, the optical sensor 201 is provided at a position where the display element 102 is not installed on the display board 101. The optical sensor 201 detects that an object such as a finger has come into contact with the screen. The optical sensor 201 may be, for example, a photodiode. A signal detected by the optical sensor 201 is transmitted to the control unit 103.

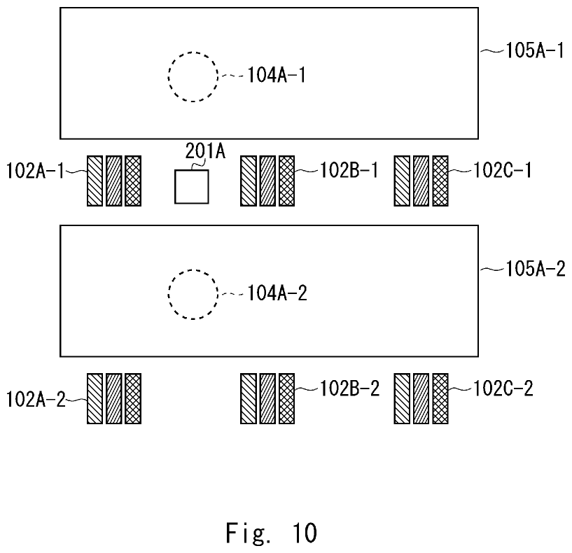

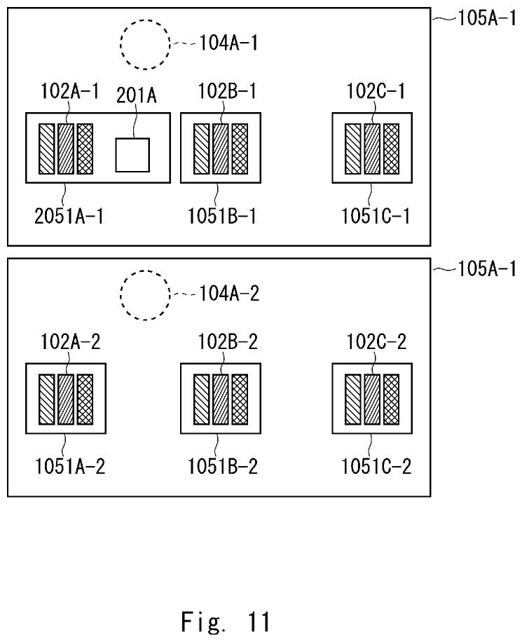

FIGS. 10 and 11 are diagrams illustrating an example of arrangement of the display elements 102, the optical sensor 201, and the planar antennas 105 according to the second example embodiment. FIGS. 10 and 11 illustrate examples of arrangement of the display elements 102, the planar antennas 105, the optical sensor 201, and the like in a case where a part of the screen of the touch panel 100 according to the second example embodiment is viewed from above. Note that all the display elements 102 and all the planar antennas 105 of the touch panel 100 may be arranged in either one of as in FIGS. 10 and 11. In addition, some of sets of one or more display elements 102 and one or more planar antennas 105 of the touch panel 100 may be arranged as in FIG. 10, and the remaining sets may be arranged as in FIG. 11.

In the example of FIG. 10, each planar antenna 105 is provided at a position between a display element 102 (for example, display element 102-1) and the optical sensor 201 and another display element 102 (for example, display element 102-2) as viewed from above the screen of the touch panel 100. In addition, in the example of FIG. 11, the planar antenna 105A-1 has an opening 2051A-1 at a position facing the display element 102A-1 and the optical sensor 201 when viewed from above the screen of the touch panel 100.

The control unit 103 may cause the display element 102 to emit light of at least one of blue and red for a short period of time (short pulse drive), and detect whether or not an object such as a finger is present by using the optical sensor 201. Thus, for example, the touch can be detected even in a relatively dark region of the display screen. This is because human eyes have good (high) sensitivity to green and relatively poor (low) sensitivity to blue and red.

In addition, the control unit 103 may increase the intensity (luminance, brightness) of light emission of the display element 102 at the touched position. Thus, for example, the light emission of the display element 102 is blocked by an object such as a finger, and thus, it is possible to improve the accuracy of the detection by the optical sensor 201 while reducing the user's feeling of glare. In this case, the control unit 103 may increase the intensity of light emission of at least one of blue and red of the display element 102 at the touched position. Thus, for example, it is possible to reduce the user's feeling of glare when the touch of the finger or the like is stopped.

In addition, the display element 102 may include an LED that emits infrared light (IR-LED) in addition to the three LEDs of red, green, and blue. Then, the control unit 103 may cause the IR-LED to emit light as appropriate. Thus, for example, it is possible to improve the accuracy of the detection by the optical sensor 201 while reducing the user's feeling of glare.

### Third Example Embodiment

In the above-described examples, the example in which the touch sensor 106 or the optical sensor 201 separate from the planar antenna 105 is used has been described. Hereinafter, an example in which the planar antenna 105 is used as at least a part of the touch sensor will be described. Note that, in the following, a main part of the third example embodiment different from the first example embodiment will be described. Note that each unit of the third example embodiment, each unit of the first example embodiment, and each unit of the second example embodiment can be appropriately combined and used. In this case, for example, at least one of the touch sensor 106 of the first example embodiment and the optical sensor 201 of the second example embodiment may be used for a partial region of the screen region of the touch panel 100. Then, a touch sensor using the planar antenna 105 may be used for other regions of the screen region of the touch panel 100.

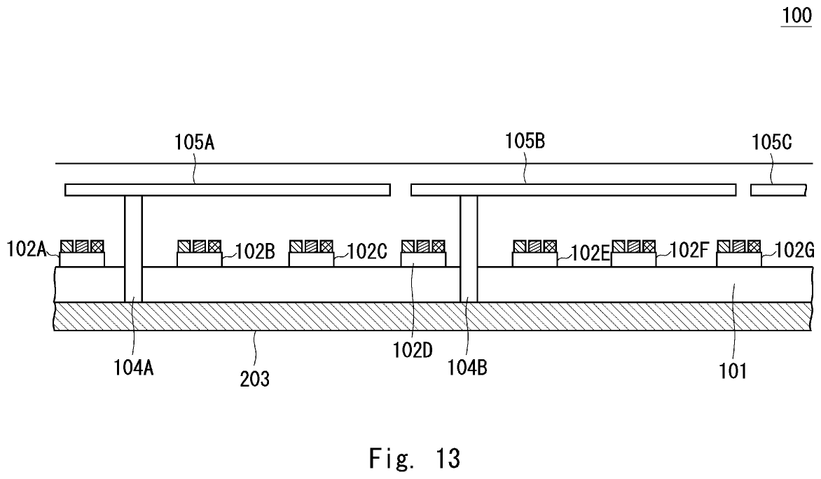

An example of a configuration of the touch panel 100 of the information processing apparatus 10 according to the third example embodiment will be described with reference to FIG. 13. FIG. 13 is a diagram illustrating an example of a configuration of the touch panel 100 according to the third example embodiment.

The example of FIG. 13 is different from the example of FIG. 2 in that the touch sensor 106 is not provided. Thus, for example, the number of components can be reduced. In addition, the example of FIG. 13 is different from the example of FIG. 2 in that a control unit 203 is provided instead of the control unit 103. The control unit 203 according to the third example embodiment has a function of an electromagnetic resonance (EMR) sensor in addition to at least some of the functions of the control unit 103 according to the first example embodiment. Therefore, the control unit 203 according to the third example embodiment is an example of the “touch sensor”.

The planar antenna 105 has a conductor. Therefore, when a dedicated pen (touch pen) that generates a magnetic field, a finger, or the like is brought close to the screen of the touch panel 100, antenna characteristics (particularly, impedance characteristics) of the planar antenna 105 change due to electromagnetic induction.

The control unit 203 detects contact with the touch panel 100 on the basis of a change in antenna characteristics when the planar antenna 105 is contacted. In this case, the control unit 203 may determine that the planar antenna 105 is in contact when the antenna characteristics of the planar antenna 105 change in a predetermined pattern. In addition, the control unit 203 may determine a position corresponding to the contact planar antenna 105 among the plurality of planar antennas 105 as the contact position on the screen of the touch panel 100.

<Effects of the Present Disclosure>

For example, a case will be considered in which the installation cost of the base station is reduced by loading the base station on a satellite or the like, and broadband communication can be performed even in a remote island, a remote area, an airplane, or a ship. In the case of using radio waves in a high frequency band such as millimeter waves and terahertz waves, it is necessary to increase the total area of the antenna (increase the size of the antenna module) in the terminal in order to communicate with a base station at a far distance installed on a satellite or the like.

As described above, according to the present disclosure, for example, power is supplied to the planar antenna 105 on the front surface side of the screen of the touch panel 100 from between the display elements (light emitting elements) 102 such as micro LEDs. Thus, a communicable distance in wireless communication can be increased. This is because the antenna module can be increased in size because the display of the terminal also serves as the antenna while leaving no shielding in front of the antenna.

Next, a modified example of the example embodiment of the present disclosure will be described. The following modified examples may be implemented by appropriately combining with the example embodiment of the present disclosure.

<Modified Example>

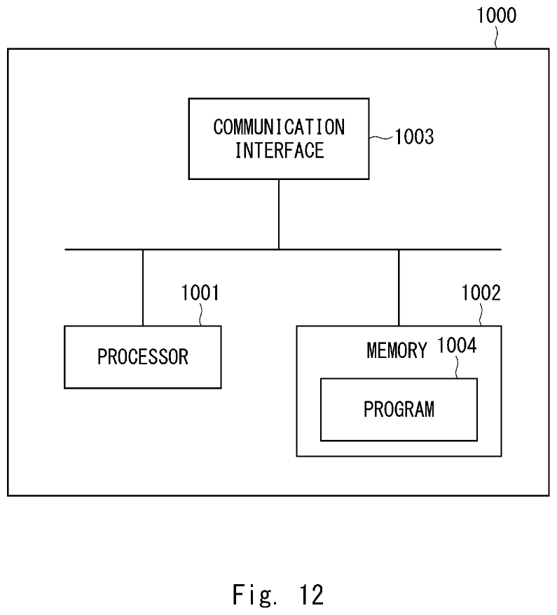

FIG. 12 is a diagram illustrating an example of a configuration of a computer 1000 in a case where at least a part (for example, the control unit 103) of the information processing apparatus 10 is achieved by a computer and a program. In the example of FIG. 12, the computer 1000 includes a processor 1001, a memory 1002, and a communication interface 1003. These units may be connected by a bus or the like. The memory 1002 stores at least a part of a program 1004. The communication interface 1003 includes an interface necessary for communication with other network elements.

When the program 1004 is executed by the processor 1001, the memory 1002, and the like in cooperation with each other, at least a part of the processing of the example embodiment of the present disclosure is performed by the computer 1000. The memory 1002 may be of any type suitable for a local technology network. The memory 1002 may be a non-transitory computer-readable storage medium, as a non-limiting example. In addition, the memory 1002 may also be implemented using any suitable data storage technology, such as semiconductor-based memory devices, magnetic memory devices and systems, optical memory devices and systems, fixed memory and removable memory, and the like. Although only one memory 1002 is illustrated in the computer 1000, there may be several physically different memory modules in the computer 1000. The processor 1001 may be of any type. The processor 1001 may include one or more of a general purpose computer, a dedicated computer, a microprocessor, a digital signal processor (DSP), and a processor based on a multi-core processor architecture as a non-limiting example. The computer 1000 may have multiple processors, such as an application specific integrated circuit chip that is temporally dependent on a clock that synchronizes the main processor.

The example embodiments of the present disclosure may be implemented in hardware or dedicated circuitry, software, logic, or any combination thereof. Some aspects may be implemented in hardware, while other aspects may be implemented in firmware or software that may be executed by a controller, microprocessor or other computing device.

The present disclosure also provides at least one computer program product tangibly stored on a non-transitory computer-readable storage medium. The computer program product includes computer-executable instructions, such as those included in a program module, and executes on a device on the subject real or virtual processor to perform the processes or methods of the present disclosure. Program modules include routines, programs, libraries, objects, classes, components, data structures, and the like that execute particular tasks or implement particular abstract data types. The functionality of the program modules may be combined or divided between the program modules as desired in various example embodiments. The machine-executable instructions of the program module can be executed in a local or distributed device. In a distributed device, program modules can be located on both local and remote storage media.

Program code for executing the methods of the present disclosure may be written in any combination of one or more programming languages. These program codes are provided to a processor or controller of a general purpose computer, dedicated computer, or other programmable data processing apparatus. When the program code is executed by a processor or controller, the functions/acts in the flowcharts and/or the implementing block diagrams are performed. The program code executes entirely on the machine, partly on the machine, as a stand-alone software package, partly on the machine, partly on a remote machine, or entirely on the remote machine or server.

The program can be stored and supplied to the computer using various types of non-transitory computer readable media. Non-transitory computer readable media include various types of tangible storage media. Examples of the non-transitory computer readable medium include a magnetic recording medium, a magneto-optical recording medium, an optical disc medium, a semiconductor memory, and the like. The magnetic recording medium includes, for example, a flexible disk, a magnetic tape, a hard disk drive, and the like. The magneto-optical recording medium includes, for example, a magneto-optical disk and the like. The optical disc medium includes, for example, a Blu-ray disc, a compact disc (CD)-read only memory (ROM), a CD-recordable (R), a CD-rewritable (RW), and the like. The semiconductor memory includes, for example, a mask ROM, a programmable ROM (PROM), an erasable PROM (EPROM), a flash ROM, a random access memory (RAM)), and the like. In addition, the program may be supplied to the computer using various types of transitory computer readable media. Examples of the transitory computer readable media include electrical signals, optical signals, and electromagnetic waves. The transitory computer readable media can provide the program to the computer via a wired communication line such as an electric wire and optical fibers or a wireless communication line.

Note that the present invention is not limited to the above example embodiments, and can be appropriately changed without departing from the scope of the present invention.

Some or all of the above-described example embodiments may be described as in the following Supplementary Notes, but are not limited to the following Supplementary Notes.

(Supplementary Note 1)

An information processing apparatus including:

a touch panel;

a display board configured to include a first display element that displays a first pixel that is one pixel of a screen of the touch panel and a second display element that displays a second pixel that is one pixel different from the first pixel of the screen;

a touch sensor configured to detect contact with the screen;

a planar antenna configured to be provided at a position on a front surface side of the screen with respect to the display board and the touch sensor, the position not facing the first display element and the second display element when viewed from above the screen; and

a control means for performing at least one of reception of a signal from the planar antenna and transmission of a signal to the planar antenna via a space between the first display element and the second display element.

(Supplementary Note 2)

The information processing apparatus according to supplementary note 1, in which the planar antenna is provided at a position between the first display element and the second display element when viewed from above the screen.

(Supplementary Note 3)

The information processing apparatus according to supplementary note 1 or 2, in which the planar antenna has an opening at a position facing at least one of the first display element and the second display element when viewed from above the screen.

(Supplementary Note 4)

The information processing apparatus according to any one of supplementary notes 1 to 3, including:

a support means for passing between the first display element and the second display element and supporting the planar antenna.

(Supplementary Note 5)

The information processing apparatus according to supplementary note 4, in which the touch sensor has an opening at a position corresponding to the support means.

(Supplementary Note 6)

The information processing apparatus according to supplementary note 4 or 5, in which the control means performs at least one of the reception of the signal from the planar antenna and the transmission of the signal to the planar antenna via a conductor of the support means.

(Supplementary Note 7)

The information processing apparatus according to any one of supplementary notes 1 to 6, including:

a plurality of planar antennas at a first density on the front surface side of the screen with respect to the display board and the touch sensor in a region of a central portion of the screen,

a plurality of planar antennas at a second density higher than the first density on the front surface side of the screen with respect to the display board and the touch sensor in a region of an edge portion of the screen.

(Supplementary Note 8)

The information processing apparatus according to any one of supplementary notes 1 to 7, in which the control means performs at least one of reception and transmission by using a planar antenna corresponding to a region other than a region on the screen where contact is detected by the touch sensor among the plurality of planar antennas provided on the front surface side of the screen with respect to the display board and the touch sensor.

(Supplementary Note 9)

The information processing apparatus according to any one of supplementary notes 1 to 8, in which the control means performs at least one of reception and transmission by using a planar antenna corresponding to a region other than a region on the screen in which a frequency at which contact is detected by the touch sensor is equal to or greater than a threshold when display is performed on the screen by a specific application program.

(Supplementary Note 10)

The information processing apparatus according to any one of supplementary notes 1 to 9, in which the control means performs at least one of reception and transmission by using a planar antenna corresponding to a region other than a region on the screen where a graphical user interface (GUI) component for pressing is displayed.

(Supplementary Note 11)

The information processing apparatus according to any one of supplementary notes 1 to 10, in which the control means wirelessly performs at least one of the reception of the signal from the planar antenna and the transmission of the signal to the planar antenna.

(Supplementary Note 12)

The information processing apparatus according to any one of supplementary notes 1 to 11, including:

an insulating layer between the touch sensor and the planar antenna.

(Supplementary Note 13)

The information processing apparatus according to any one of supplementary notes 1 to 12, in which the touch sensor detects contact with the screen by at least one of a projected capacitive type and an electromagnetic induction type.

(Supplementary Note 14)

The information processing apparatus according to any one of supplementary notes 1 to 13, in which the touch sensor detects contact with the screen using an optical sensor.

(Supplementary Note 15)

The information processing apparatus according to supplementary note 14, in which the control means increases intensity of light emission of the first display element corresponding to a region on the screen where contact is detected.

(Supplementary Note 16)

The information processing apparatus according to supplementary note 15, in which the control means increases intensity of light emission of at least one of blue and red of the first display element corresponding to a region on the screen where contact is detected.

(Supplementary Note 17)

The information processing apparatus according to any one of supplementary notes 14 to 16, in which the first display element emits infrared light.

(Supplementary Note 18)

The information processing apparatus according to any one of supplementary notes 1 to 17, in which the touch sensor detects contact with the touch panel on the basis of a change in antenna characteristics when the planar antenna is contacted.

(Supplementary Note 19)

A touch panel including:

a display board configured to include a first display element that displays a first pixel that is one pixel of a screen of the touch panel and a second display element that displays a second pixel that is one pixel different from the first pixel of the screen;

a touch sensor configured to detect contact with the screen;

a planar antenna configured to be provided at a position on a front surface side of the screen with respect to the display board and the touch sensor, the position not facing the first display element and the second display element when viewed from above the screen; and a control means for performing at least one of reception of a signal from the planar antenna and transmission of a signal to the planar antenna via a space between the first display element and the second display element.

(Supplementary Note 20)

The touch panel according to supplementary note 19, in which the planar antenna is provided at a position between the first display element and the second display element when viewed from above the screen.

This application claims priority based on Japanese Patent Application No. 2021-056695 filed on Mar. 30, 2021, the entire disclosure of which is incorporated herein.

### REFERENCE SIGNS LIST

1 WIRELESS COMMUNICATION SYSTEM
10 INFORMATION PROCESSING APPARATUS
100 TOUCH PANEL
101 DISPLAY BOARD
102 DISPLAY ELEMENT
103 CONTROL UNIT
104 SUPPORT
105 PLANAR ANTENNA
106 TOUCH SENSOR
1051 OPENING
1061 OPENING
201 OPTICAL SENSOR (TOUCH SENSOR)
203 CONTROL UNIT (TOUCH SENSOR)
20 BASE STATION

What is claimed is:

1. An information processing apparatus comprising:
a touch panel;
a display board configured to include a first display element that displays a first pixel that is one pixel of a screen of the touch panel and a second display element that displays a second pixel that is one pixel different from the first pixel of the screen;
a touch sensor configured to detect contact with the screen;
a planar antenna configured to be provided at a position on a front surface side of the screen with respect to the display board and the touch sensor, the position not facing the first display element and the second display element when viewed from above the screen; and
a control means for performing at least one of reception of a signal from the planar antenna and transmission of a signal to the planar antenna via a space between the first display element and the second display element.

2. The information processing apparatus according to claim 1, wherein the planar antenna is provided at a position between the first display element and the second display element when viewed from above the screen.

3. The information processing apparatus according to claim 1, wherein the planar antenna has an opening at a position facing at least one of the first display element and the second display element when viewed from above the screen.

4. The information processing apparatus according to claim 1, comprising:
a support means for passing between the first display element and the second display element and supporting the planar antenna.

5. The information processing apparatus according to claim 4, wherein the touch sensor has an opening at a position corresponding to the support means.

6. The information processing apparatus according to claim 4, wherein the control means performs at least one of the reception of the signal from the planar antenna and the transmission of the signal to the planar antenna via a conductor of the support means.

7. The information processing apparatus according to claim 1, comprising:
a plurality of planar antennas at a first density on the front surface side of the screen with respect to the display board and the touch sensor in a region of a central portion of the screen,
a plurality of planar antennas at a second density higher than the first density on the front surface side of the screen with respect to the display board and the touch sensor in a region of an edge portion of the screen.

8. The information processing apparatus according to claim 1, wherein the control means performs at least one of reception and transmission by using a planar antenna corresponding to a region other than a region on the screen where contact is detected by the touch sensor among the plurality of planar antennas provided on the front surface side of the screen with respect to the display board and the touch sensor.

9. The information processing apparatus according to claim 1, wherein the control means performs at least one of reception and transmission by using a planar antenna corresponding to a region other than a region on the screen in which a frequency at which contact is detected by the touch sensor is equal to or greater than a threshold when display is performed on the screen by a specific application program.

10. The information processing apparatus according to claim 1, wherein the control means performs at least one of reception and transmission by using a planar antenna corresponding to a region other than a region on the screen where a graphical user interface (GUI) component for pressing is displayed.

11. The information processing apparatus according to claim 1, wherein the control means wirelessly performs at least one of the reception of the signal from the planar antenna and the transmission of the signal to the planar antenna.

12. The information processing apparatus according to claim 1, comprising:
an insulating layer between the touch sensor and the planar antenna.

13. The information processing apparatus according to claim 1, wherein the touch sensor detects contact with the screen by at least one of a projected capacitive type and an electromagnetic induction type.

14. The information processing apparatus according to claim 1, wherein the touch sensor detects contact with the screen using an optical sensor.

15. The information processing apparatus according to claim 14, wherein the control means increases intensity of light emission of the first display element corresponding to a region on the screen where contact is detected.

16. The information processing apparatus according to claim 15, wherein the control means increases intensity of light emission of at least one of blue and red of the first display element corresponding to a region on the screen where contact is detected.

17. The information processing apparatus according to claim 14, wherein the first display element emits infrared light.

18. The information processing apparatus according to claim 1, wherein the touch sensor detects contact with the touch panel on a basis of a change in antenna characteristics when the planar antenna is contacted.

19. A touch panel comprising:
a display board configured to include a first display element that displays a first pixel that is one pixel of a screen of the touch panel and a second display element that displays a second pixel that is one pixel different from the first pixel of the screen;
a touch sensor configured to detect contact with the screen;
a planar antenna configured to be provided at a position on a front surface side of the screen with respect to the display board and the touch sensor, the position not facing the first display element and the second display element when viewed from above the screen; and
a control unit for performing at least one of reception of a signal from the planar antenna and transmission of a signal to the planar antenna via a space between the first display element and the second display element.

20. The touch panel according to claim 19, wherein the planar antenna is provided at a position between the first display element and the second display element when viewed from above the screen.
